(19) United States
(12) Patent Application Publication
(10) Pub. No.: US 2020/0352075 A1
(43) Pub. Date: Nov. 12, 2020

(54) WEED REMOVAL TOOL

(71) Applicant: Amy Benson Ravetto, Irvine, CA (US)

(72) Inventor: Amy Benson Ravetto, Irvine, CA (US)

(21) Appl. No.: 16/596,646

(22) Filed: Oct. 8, 2019

Related U.S. Application Data
(60) Provisional application No. 62/845,716, filed on May 9, 2019.

(51) Int. Cl. A01B 1/16

(52) U.S. Cl. CPC A01B 1/16

(57) ABSTRACT

The invention is a weed removal hand-tool that facilitates the removal of weeds. The hand-tool includes a raked scoop extending from a terminal end of an elongated handle situated along a similar longitudinal axis, which facilitates the use of the tool—typically involving a twisting motion for easily de-rooting and ripping out weeds. The raked scoop includes a curved surface that dips below the longitudinal axis of the handle so that rake teeth extending laterally from the sides of the curved surface define a wide opening above the raked scoop. This wide opening defined in part by the various rake teeth of the raked scoop, allows the user to efficiently pull undesirable plants or weeds from their roots without having to touch them. In exemplary embodiments, the raked scoop includes at least one aperture on the curved surface for unwanted soil to filter through during the weed removal process.

### PRIORITY NOTICE

The present application claims priority under 35 U.S.C. § 119(e) to U.S. Provisional Patent Application Serial No. 62/845,716 filed on May 9, 2019, the disclosure of which is incorporated herein by reference in its entirety.

### TECHNICAL FIELD OF THE INVENTION

The present disclosure relates generally to horticultural or gardening tools. More specifically, the present disclosure relates to a weed removal tool.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever. Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

It is well known in the field of horticulture or gardening that weeds are difficult to manage and are often undesirable. As we grow more conscientious of our environment and our pets, we have also realized that pesticides—often used to kill undesired plants and weeds—are dangerous and often poisonous to humans and pets and can cause illnesses. Thus, weeds are preferably pulled or removed manually. However, manually pulling weeds takes time and is inefficient, meaning that there is a need for a special tool that facilitates the otherwise rigorous process.

Gardening tools of all types, including weed removal tools, have been around for many years. In fact, the prior art is riddled with disclosures discussing various gardening or horticultural devices. Some gardening tools include rakes, shovels, scraping tools, and other earth-working tools having a variety of shapes and different types of handles for their intended purpose. Yet, from all the types of gardening tools available in the prior art, none appear to suitably tackle the problem of efficiently removing weeds from a garden.

For example, some weed removal tools include complex mechanisms that are meant to mechanically actuate and grapple undesired weeds. The problem with these tools is that they are much too expensive due to their more complex mechanisms. Other tools attempt more efficient designs that avoid the complex mechanisms and facilitate pulling out the undesired weeds, but require the operator to use their hands in order to complete the weed-pulling process. Yet other methods of removing undesired weeds include not tools but chemicals. This latter approach of course has many shortcomings including the fact that chemical weed killers are typically toxic and undesirable in certain types of gardens—for example in home gardens accessible to children or pets.

Accordingly, there is an unanticipated or inadequately addressed need for an improved horticultural or gardening tool that facilitates weed removal, that reduces the effort required to pull weeds from the roots, and that employs a non-toxic means of weed removal.

Therefore, there is a need for a weed removal tool that addresses the above-mentioned concerns and it is to these ends that the present invention has been developed.

### SUMMARY OF THE INVENTION

To minimize the limitations in the prior art, and to minimize other limitations that will be apparent upon reading and understanding the present specification, the present invention describes a weed removal tool.

Generally, the invention involves a weed removal tool that facilitates the removal of weeds for horticultural or gardening purposes. The weed removal tool includes a raked scoop extending from a terminal end of an elongated handle situated along a similar longitudinal axis, which facilitates the use of the tool—typically involving a twisting motion for easily de-rooting and ripping out undesired weeds. The raked scoop generally includes a curved surface that dips below the longitudinal axis of the handle so that rake teeth extending laterally from the sides of the curved surface of the scoop define a wide opening above the raked scoop. This wide opening defined in part by the various rake teeth of the raked scoop, allows the user to efficiently pull undesirable plants or weeds from their roots without having to touch them.

Use of the device may be as simple as twisting the handle of the device along its longitudinal axis to simply scoop out the entire undesirable weed. Because the weed removal tool may include openings in its curved surface, any extra soil may be filtered out through a bottom region of the raked scoop.

Construction of the device is also fairly simple and may be achieved inexpensively using known techniques such as three-dimensional (3D) printing techniques and or prototyping techniques for forming molds. Materials may include metals or plastics or a combination of both; metals may include stainless steel and or aluminum.

In some exemplary embodiments, a weed removal device in accordance with some exemplary embodiments of the present invention, may include: a handle having a longitudinal axis; and a raked scoop extending from a terminal end of the handle and situated along the longitudinal axis of the handle; wherein the raked scoop has a curved surface that dips below the longitudinal axis of the handle; wherein the raked scoop includes a first set of rake teeth that extend laterally from a first side of the curved surface and a second set of rake teeth that extend laterally from a second side of the curved surface, the first and second set of rake teeth extending to or below a height along the longitudinal axis.

In some exemplary embodiments, a weed removal device in accordance with some exemplary embodiments of the present invention, may include: a handle having a longitudinal axis; and a raked scoop extending from a terminal end of the handle and situated along the longitudinal axis of the handle; wherein the raked scoop includes a pointed tip at a front end of a curved surface that dips below the longitudinal axis of the handle, the curved surface including a single aperture on the curved surface of the raked scoop; wherein the raked scoop includes a first set of rake teeth that extend laterally from a first side of the curved surface and a second set of rake teeth that extend laterally from a second side of the curved surface, the first and second set of rake teeth symmetrical to each other and extending to or below a height along the longitudinal axis.

In some exemplary embodiments, a weed removal device in accordance with some exemplary embodiments of the present invention, may include: a handle having a longitudinal axis; and a raked scoop extending from a terminal end of the handle and situated along the longitudinal axis of the handle; wherein the raked scoop includes a pointed tip defined by two sharp edges on a front end of a curved surface that dips below the longitudinal axis of the handle, the curved surface including a plurality of apertures on the curved surface of the raked scoop; wherein the raked scoop includes a first set of rake teeth that extend laterally from a first side of the curved surface and a second set of rake teeth that extend laterally from a second side of the curved surface, the first and second set of rake teeth extending to or below a height along the longitudinal axis.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

The devices as disclosed herein are further described in terms of exemplary embodiments. These exemplary embodiments are described in detail with reference to the drawings, which have not necessarily been drawn to scale in order to enhance their clarity and improve understanding of the various embodiments of the invention. Furthermore, elements that are known to be common and well understood to those in the industry are not depicted in order to provide a clear view of the various embodiments of the invention. These embodiments are non-limiting exemplary embodiments, in which like reference numerals represent similar structures throughout the several views of the drawings. The drawings that accompany the detailed description can be briefly described as follows:

FIG. 1 illustrates a perspective view of a weed removal tool in accordance with some exemplary embodiments of the present invention.

FIG. 2 illustrates a top perspective view of a weed removal tool in accordance with some exemplary embodiments of the present invention.

FIG. 3 illustrates a top front view of a weed removal tool in accordance with some exemplary embodiments of the present invention.

FIG. 4 illustrates a bottom view of a weed removal tool in accordance with some exemplary embodiments of the present invention.

FIG. 5 illustrates a side view of a weed removal tool in accordance with some exemplary embodiments of the present invention.

FIG. 6 illustrates a perspective view of a weed removal tool, depicting a manner of using the weed removal tool in accordance with exemplary embodiments of the present invention.

FIG. 7 illustrates a perspective view of a weed removal tool in accordance with some exemplary embodiments of the present invention.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized, and changes may be made without departing from the scope of the invention. Wherever possible, the same reference numbers are used in the drawings and the following description to refer to the same or similar elements.

In the following detailed description, numerous specific details are set forth by way of examples in order to provide a thorough understanding of the relevant teachings. However, it should be apparent to those skilled in the art that the present teachings may be practiced without such details. In other instances, well known structures, components and/or functional or structural relationship thereof, etc., have been described at a relatively high-level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example” as used herein does not necessarily refer to the same embodiment and the phrase “in another embodiment/example” as used herein does not necessarily refer to a different embodiment. It is intended, for example, that claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and or steps. Thus, such conditional language is not generally intended to imply that features, elements and or steps are in any way required for one or more embodiments, whether these features, elements and or steps are included or are to be performed in any particular embodiment.

The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present. The term “and or” means that “and” applies to some embodiments and “or” applies to some embodiments. Thus, A, B, and or C can be replaced with A, B, and C written in one sentence and A, B, or C written in another sentence. A, B, and or C means that some embodiments can include A and B, some embodiments can include A and C, some embodiments can include B and C, some embodiments can only include A, some embodiments can include only B, some embodiments can include only C, and some embodiments include A, B, and C. The term “and or” is used to avoid unnecessary redundancy. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

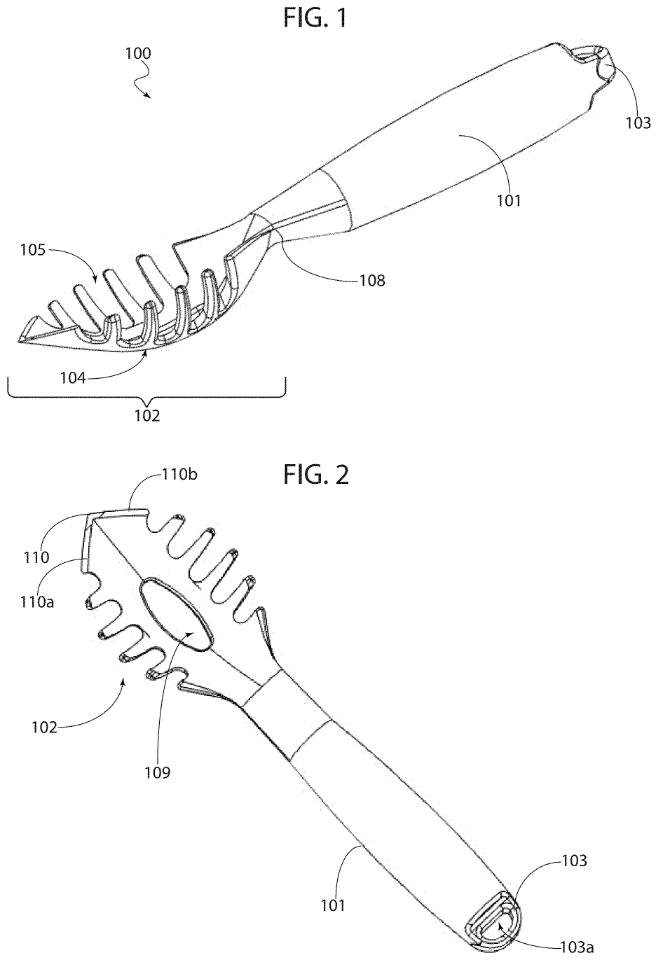

Turning now to the figures, the present disclosure relates to, among other things, horticultural or gardening tools. FIG. 1 illustrates a perspective view of a weed removal tool in accordance with some exemplary embodiments of the present invention. More specifically, this view shows weed removal tool 100, which in exemplary embodiments such as the one shown in this view, comprises a handle 101, and a raked scoop 102 extending from a terminal end of the handle 101 which is situated along the same longitudinal axis of the handle 101.

Handle 101 is typically a tubular or cylindrical handle with an elongated shape so that it is easily gripped by a user's hand. In some exemplary embodiments, handle 101 includes an ergonomic design specifically configured for use by a right-handed user or a left-handed user. In some exemplary embodiments, such as the one shown in FIG. 1 and FIG. 2, handle 101 includes an ergonomic design configured for use by either a right-handed user or a left-handed user. At a terminal end of the handle 101 that is opposite the terminal end from which raked scoop 102 extends, a looped structure, aperture, or ringed terminal end 103 may be formed and configured for hanging the weed removal tool 100 from a hanger, such as a hanger in a garage or shed from which tools may be hanged.

Raked scoop 102 may be shaped similar to a spoon or an ice cream scoop, except perhaps longer and in some embodiments oblong and oval so that raked scoop 102 is an elongated structure. So that the tool may easily dig into the earth or soil to unearth unwanted plants or weeds, raked scoop 102 typically comprises a curved surface 104 from which several rake teeth extend laterally from either side of the curved surface 104. As will be discussed with reference to other figures below, the rake teeth of raked scoop 102 facilitate de-rooting and ripping out undesired weeds.

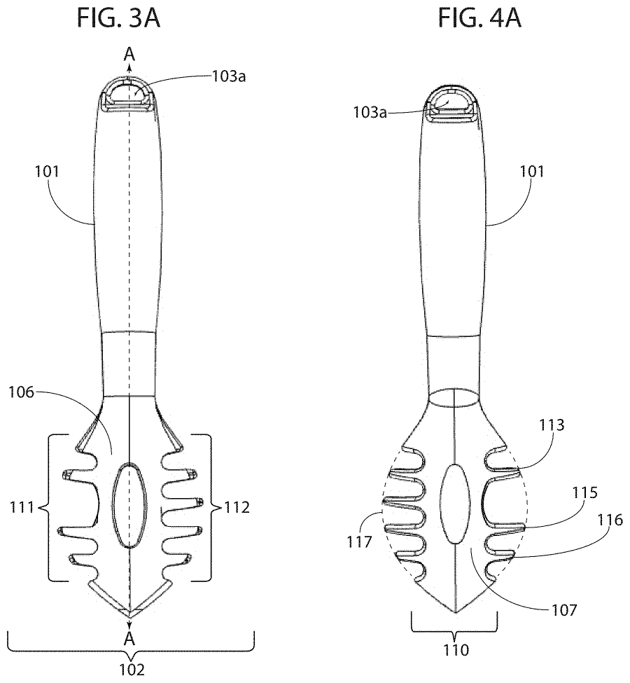

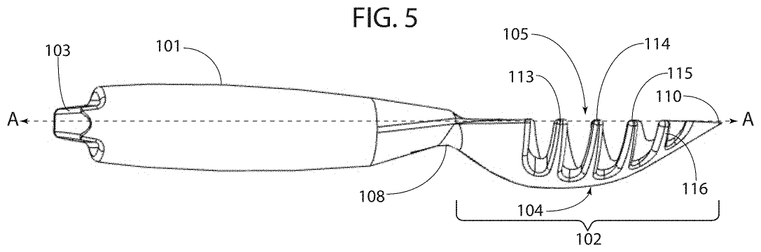

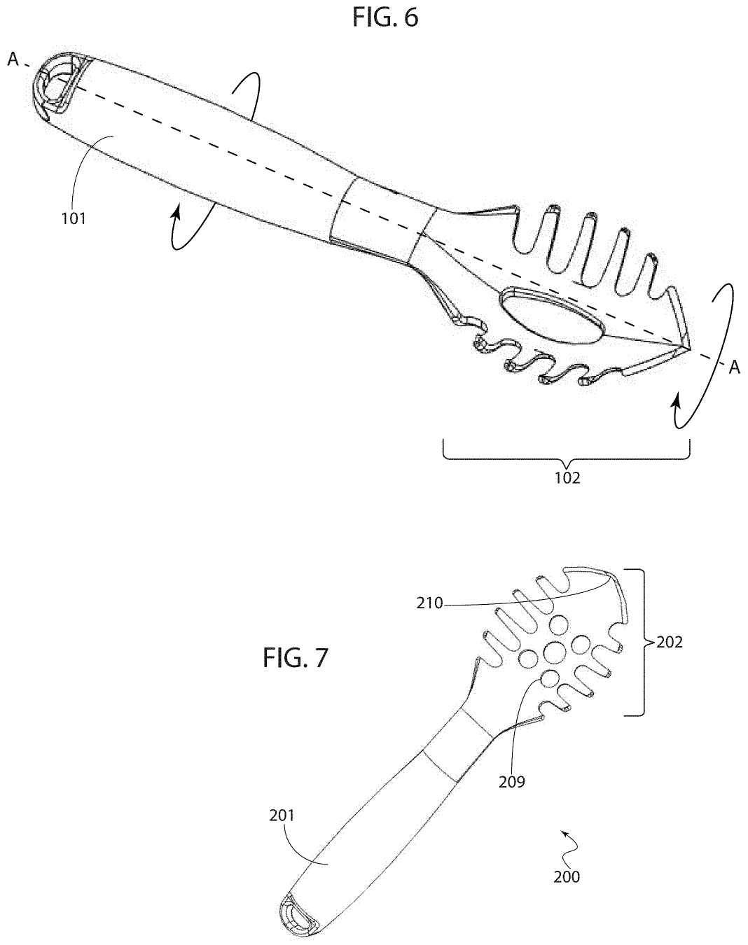

Curved surface 104 includes a curved interior concave surface 106 and a curved exterior convex surface 107 (i.e. see FIG. 3 and FIG. 4 for example) that form the curvature of the scoop shape, which generally dips below the longitudinal axis of the handle (i.e. see FIG. 5 and FIG. 6 for example) so that rake teeth of the scoop (see also FIG. 3 and FIG. 4) extending laterally from the sides of the curved surface 104 define a wide opening 105 above the curved surface 104 of raked scoop 102.

Typically, between handle 101 and raked scoop 102, and more specifically at a terminal end of handle 101, a narrowing of handle 101 defines a neck portion 108 connecting handle 101 to raked scoop 102. In exemplary embodiments, the handle portion and the scoop portion of the weed removal tool are constructed of a single material. In other embodiments, multiple materials may be used. In some exemplary embodiments weed removal tool 100 is entirely metal. For example, and without limiting the scope of the present invention, weed removal tool 100 may comprise steel, aluminum, or a combination of these metals or other metals without deviating from the scope of the present invention. In yet other embodiments, weed removal tool 100 may be constructed of a durable hard plastic. Construction of the device may be achieved inexpensively using known techniques such as 3D printing techniques and or prototyping techniques for forming molds, or a combination of the same.

Accordingly, in some exemplary embodiments, weed removal tool 100 may comprise: a handle 101 having a longitudinal axis; and a raked scoop 102 extending from a terminal end of the handle 101 and situated along the longitudinal axis of the handle 101, wherein the raked scoop 102 has a curved surface 104 that dips below the longitudinal axis of the handle 101, and wherein the raked scoop 102 includes rake teeth extending laterally from the sides of the curved surface 104 of the raked scoop 102, which define a wide opening 105 above the raked scoop 102. This wide opening 105 defined in part by the various rake teeth of the raked scoop 102, allows the user to efficiently pull undesirable plants or weeds from their roots without having to touch them.

Turning now to the next figure, FIG. 2 illustrates a top perspective view of weed removal tool in accordance with some exemplary embodiments of the present invention. More specifically, this view of weed removal tool 100 depicts how at least one aperture 109 is formed on interior concave surface 106 of the curved surface 104 of the raked scoop 102. As mentioned above, aperture 109 is configured to allow any extra soil caught within wide opening 105 to be filtered out via a bottom region of the raked scoop 102. In exemplary embodiments, aperture 109 is a single aperture on the curved surface 104 of the raked scoop 102 and is an oblong oval aperture. As will be discussed with reference to FIG. 7 below, in other exemplary embodiments, multiple apertures may be formed to accommodate a structural integrity of the device, depending on the type of material used for constructing weed removal tool 100. Accordingly, in some embodiments weed removal tool 100 may include a single aperture, while in other embodiments weed removal tool 100 may include multiple apertures without limiting or deviating from the scope of the present invention.

Moreover, from this view the looped structure, aperture, or ringed terminal end 103 that may be exemplarily formed at a terminal end of handle 101 is shown. In such exemplary embodiments, ringed terminal end 103 forms an aperture 103a at the terminal end opposite to the raked scoop 102; the aperture 103a configured to allow hanging weed removal tool 100 from a hanger in a shed, garage, or other tool suitable place.

In order to facilitate digging into soil and other useful functions during weed removal, weed removal tool 100 may include a pointed tip 110. In exemplary embodiments, pointed tip 110 may be defined by two sharp edges 110a and 110b that form a triangular region at the front end of the device, which may be useful in digging and picking at the targeted soil. FIG. 3 shows a top view of pointed tip 110 whereby a top surface of the region is concavely curved, and FIG. 4 also shows a bottom view of pointed tip 110 whereby a bottom surface of the region is convexly curved.

Now turning to FIG. 3 and FIG. 4, these views illustrate a top front view of weed removal tool 100, and a bottom view of weed removal tool 100, respectively. Turning first to FIG. 3, a top view of weed removal tool 100 shows raked scoop 102 from a top view revealing curved interior concave surface 106, which includes aperture 109 along a center region therein so that aperture 109 sits longitudinally along the center of the curved interior concave surface 106. From either side of raked scoop 102, and more specifically extending laterally from curved interior concave surface 106, a first set of rake teeth 111 extend from a first side of the curved surface 104 and a second set of rake teeth 112 extend from a second side of the curved surface 104. As may be appreciated from this top view, both the first and second set of rake teeth 111 and 112 extend substantially perpendicular to a longitudinal axis A-A of weed removal tool 100; substantially referring to the fact that each of the multiple rake teeth may extend at or approximately at a 90° angle with respect to the longitudinal axis A-A of weed removal tool 100.

As may be appreciated from the bottom view of FIG. 4, exterior convex surface 107 is the bottom surface of curved surface 104. In the shown exemplary embodiment, the first set of rake teeth 111 that extend laterally from the first side of the curved surface 104 are symmetrical to the second set of rake teeth 112 that extend laterally from the second side of the curved surface 104. Accordingly, in such symmetrical embodiments, both sides of raked scoop 102 will include an equal number of rake teeth having similar complementary shapes. For example, and without limiting the scope of the present invention, the first set of rake teeth 111 may include four rake teeth 113, 114, 115, and 116; in such embodiment, as shown in FIG. 3 and FIG. 4, the second set of rake teeth 112 will also have four similarly shaped rake teeth with a similar length and curvature as rake teeth 113, 114, 115, and 116. This exemplary symmetrical configuration in which the first set of rake teeth 111 that extend laterally from the first side of the curved surface 104 are symmetrical to the second set of rake teeth 112 that extend laterally from the second side of the curved surface 104 is particularly advantageous in that the weed removal tool may be used by a right-handed user as well as a left-handed user since twisting the tool in either direction along longitudinal axis A-A (as explained further below with reference to FIG. 6) will achieve the same functional effect due to the similarities in the structure of the teeth on either side of raked scoop 102. In some exemplary embodiments in which the rake teeth are structured symmetrically, the number of rake teeth may be four on a first side and four on a second side. In some exemplary embodiments in which the rake teeth are structured symmetrically, the number of rake teeth may be three on a first side and three on a second side. Moreover, in exemplary embodiments in which the rake teeth are structured symmetrically, the number of rake teeth on each side may comprise any similar number of rake teeth without deviating from the scope of the present invention.

Typically, although not necessarily, the rake teeth at the extremities of the raked scoop 102 or the terminal teeth 113 and 116 may be shorter than the middle teeth 114 and 115. Moreover, in exemplary embodiments, their lengths may be configured such that their points contour to the general curved shape of the raked scoop 102 (i.e. their tips align along an external perimeter 117).

Of course, in some exemplary embodiments, each of the teeth may be a similar length. In some exemplary embodiments, the teeth may be aligned to form a straight line. And in yet other embodiments, the first set of rake teeth 111 that extend laterally from the first side of the curved surface 104 may be asymmetrical to the second set of rake teeth 112 that extend laterally from the second side of the curved surface 104. For example, and without limiting the scope of the present invention, in some exemplary embodiments, one side may include four rake teeth while the other side may include only three rake teeth. In some exemplary embodiments, one side may not include rake teeth at all—for example where set of rake teeth 112 is instead replaced with a solid surface that borders external perimeter 117.

Now turning to the next figure, FIG. 5 illustrates a side view of weed removal tool 100 in accordance with some exemplary embodiments of the present invention. Several characteristics of weed removal tool 100 may be appreciated from this view: handle 101 is formed along a longitudinal axis A-A; raked scoop 102 extends from a terminal end of the handle 101 and is situated along the same longitudinal axis A-A; raked scoop 102 includes a curved surface 104 that dips below the longitudinal axis A-A; and the first and second set of rake teeth 111 and 112 extend to or below a height along the longitudinal axis A-A. In exemplary embodiments such as the one shown in the present figure, curved surface 104 is defined by a single curved structure that has a terminal end at neck portion 108 and another terminal end at pointed tip 110; however, in other embodiments, curved surface 104 may be defined by multiple curves that form multiple convex exterior surfaces along the bottom (exterior) surface of raked scoop 102, and multiple concave interior surfaces along the top (interior) surface of the raked scoop 102.

Moreover, in the shown embodiment, a tip of each of the rake teeth aligns along an external perimeter 117 that contours to the general curved shape of the raked scoop 102 (see also FIG. 4) and is substantially on the same plane or at a plane at a substantially similar height to the plane along the longitudinal axis A-A.

This configuration facilitates the use of the hand-tool because the resulting structure allows a user to use a simple twist motion in order to remove unwanted plants or weeds. If rake teeth 113-116 were to extend well beyond a height above longitudinal axis A-A, the rake teeth would interfere with the twist motion and decrease the efficiency with which the tool may be effectively used. If on the other hand the rake teeth are too low in height, then the teeth would not adequately de-root and facilitate the removal of unwanted plants or weeds. The next figure illustrates a typical method of operation of a hand-tool for removing weeds in accordance with the present invention, such as weed removal tool 100.

Accordingly, in some exemplary embodiments of the present invention, weed removal tool 100 comprises: a handle 101 having a longitudinal axis A-A; and a raked scoop 102 extending from a terminal end of the handle 101 and situated along the longitudinal axis of the handle 101; wherein the raked scoop 102 includes a pointed tip 110 at a front end of a curved surface 104 that dips below the longitudinal axis A-A of the handle 101, the curved surface 104 including a single aperture 109 on an interior concaved surface 106 of the raked scoop 102; wherein the raked scoop 102 includes a first set of rake teeth 111 that extend laterally from a first side of the curved surface 104 and a second set of rake teeth 112 that extend laterally from a second side of the curved surface 104, the first and second set of rake teeth 111, 112 symmetrical to each other and extending to or below a height along the longitudinal axis A-A.

FIG. 6 illustrates a perspective view of weed removal tool 100, depicting a manner of using the weed removal tool in accordance with exemplary embodiments of the present invention. Use of the device may be as simple as twisting the handle 101 of weed removal tool 100 along its longitudinal axis A-A to simply scoop out the entire undesirable weed. Because the weed removal tool 100 may include openings (for example, a single opening or aperture 109) in its curved surface, any extra soil may be filtered out through a bottom region of the raked scoop 102.

FIG. 7 illustrates a perspective view of a weed removal tool in accordance with some exemplary embodiments of the present invention. More specifically, weed removal tool 200 is shown as another exemplary embodiment in which multiple apertures 209 are formed in the interior concaved surface of the device.

Accordingly, in some exemplary embodiments, a weed removal tool 200 may comprise: a handle 201 having a longitudinal axis; and a raked scoop 202 extending from a terminal end of the handle 201 and situated along the longitudinal axis of the handle 201; wherein the raked scoop 202 includes a pointed tip 210 defined by two sharp edges on a front end of a curved surface that dips below the longitudinal axis of the handle 201, the curved surface including a plurality of apertures 209 on the curved surface of the raked scoop 202; wherein the raked scoop includes a first set of rake teeth that extend laterally from a first side of the curved surface and a second set of rake teeth that extend laterally from a second side of the curved surface, the first and second set of rake teeth extending to or below a height along the longitudinal axis.

A weed removal tool has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

1. A weed removal tool, comprising:
a handle having a longitudinal axis; and
a raked scoop extending from a terminal end of the handle and situated along the longitudinal axis of the handle;
wherein the raked scoop has an elongated curved surface that dips below the longitudinal axis of the handle; and
wherein the raked scoop includes a first set of rake teeth that extend laterally from a first side of the elongated curved surface and a second set of rake teeth that extend laterally from a second side of the elongated curved surface, the first set of rake teeth that extend laterally from the first side of the elongated curved surface symmetrical to the second set of rake teeth that extend laterally from the second side of the elongated curved surface, the first and second set of rake teeth extending to but not beyond a height along the longitudinal axis.

2. The weed removal tool of claim 1, wherein the raked scoop includes at least one aperture on the curved surface of the raked scoop.

3. The weed removal tool of claim 2, wherein the at least one aperture on the curved surface of the raked scoop comprises a plurality of apertures in a center region of the curved surface of the raked scoop.

4. The weed removal tool of claim 1, wherein the raked scoop includes a single aperture on the curved surface of the raked scoop.

5. The weed removal tool of claim 4, wherein the single aperture on the curved surface of the raked scoop is an oblong oval aperture.

6. The weed removal tool of claim 1, wherein the raked scoop includes a pointed tip.

7. (canceled).

8. (canceled).

9. The weed removal tool of claim 1, wherein there are a greater number of rake teeth in the first set of raked teeth than in the second set of raked teeth.

10. The weed removal tool of claim 1, wherein the handle comprises a ringed terminal end configured for hanging the device from a hanger.

11. A weed removal tool, comprising:
a handle having a longitudinal axis; and
a raked scoop extending from a terminal end of the handle and situated along the longitudinal axis of the handle;
wherein the raked scoop includes a pointed tip at a front end of a curved surface that dips below the longitudinal axis of the handle, the curved surface including a single aperture on the curved surface of the raked scoop;
wherein the raked scoop includes a first set of rake teeth that extend laterally from a first side of the curved surface and a second set of rake teeth that extend laterally from a second side of the curved surface, the first and second set of rake teeth symmetrical to each other and extending to but not beyond a height along the longitudinal axis.

12. The weed removal tool of claim 11, wherein the single aperture on the curved surface of the raked scoop is an oblong oval aperture.

13. The weed removal tool of claim 11, wherein the pointed tip is defined by two sharp edges on a front end of the raked scoop.

14. The weed removal tool of claim 11, wherein the handle comprises a ringed terminal end configured for hanging the device from a hanger.

15. The weed removal tool of claim 11, wherein the handle comprises a tubular shape.

16. A weed removal tool, comprising:
a handle having a longitudinal axis; and
a raked scoop extending from a terminal end of the handle and situated along the longitudinal axis of the handle;
wherein the raked scoop includes a pointed tip defined by two sharp edges on a front end of a curved surface that dips below the longitudinal axis of the handle, the curved surface including a plurality of apertures on the curved surface of the raked scoop;
wherein the raked scoop includes a first set of rake teeth that extend laterally from a first side of the curved surface and a second set of rake teeth that extend laterally from a second side of the curved surface, the first and second set of rake teeth extending to but not beyond a height along the longitudinal axis.

17. The weed removal tool of claim 16, wherein the handle comprises a ringed terminal end configured for hanging the device from a hanger.

18. The weed removal tool of claim 16, wherein the first set of rake teeth that extend laterally from the first side of the curved surface are symmetrical to the second set of rake teeth that extend laterally from the second side of the curved surface.

19. The weed removal tool of claim 16, wherein the first set of rake teeth that extend laterally from the first side of the curved surface are asymmetrical to the second set of rake teeth that extend laterally from the second side of the curved surface.

20. The weed removal tool of claim 16, wherein the handle comprises a cylindrical handle.
